(19) United States
(12) Patent Application Publication
(10) Pub. No.: US 2003/0154446 A1
(43) Pub. Date: Aug. 14, 2003

(54) Character-based, graphically expressive mobile messaging system

(76) Inventors: Nicholas Robert Constant, Los Angeles, CA (US); Benjamin Daniel Rigby, Brooklyn, NY (US); Ardith Ibanez Rigby, Brooklyn, NY (US); Bartholomew Thomas Cheever, Los Angeles, CA (US)

Correspondence Address: MARK J. SPOLYAR, 38 FOUNTAIN ST., SAN FRANCISCO, CA, 94114, US

(21) Appl. No.: 10/058,545

(22) Filed: Jan. 28, 2002

(51) Int. Cl. G06F 15/16

(52) U.S. Cl. 715/531

(57) ABSTRACT

Methods, apparatuses and systems allowing users to send and receive character-based, graphically expressive messages using mobile wireless devices. In one embodiment, the present invention allows users to create and maintain a customized, easy-to-use visual messaging environment for use with wireless mobile devices having limited display and other interface capabilities. In one embodiment, the present invention allows users to establish a graphical character-based, messaging personality, including selectable images of the character that convey a certain mood.

### FIELD OF THE INVENTION

The present invention relates to graphical messaging systems and, more particularly, to a unified graphical messaging system allowing users to compose, send and receive character-based, graphically expressive messages using wireless mobile devices.

### BACKGROUND OF THE INVENTION

The emergence of the Internet has facilitated a variety of communications and data exchanges. For example, e-mail (electronic mail) is the exchange of computer-stored messages over a telecommunications network. E-mail messages are usually encoded in ASCII text; however, non-text files, such as graphic images and sound files, as attachments can be sent in binary streams. E-mail was one of the first uses of the Internet and is still the most popular use, comprising a large percentage of the total traffic over the Internet.

Other messaging technologies have been developed to provide more expressive messages over the Internet. For example, graphically expressive messaging systems have been deployed on the Internet. A web-based application DFILM MovieMaker™ allows users to compose short animated sequences (including the selection of characters, basic plots and dialogue), and transmit the animated sequences to others. Similarly, U.S. patent application Ser. No. 09/870,317, filed May 30, 2001 discloses a messaging system that receives a plain text message, analyzes the message to distill the main concept from it, and composes an animated sequence associated with the main concept. For example, if a text message “Want to go to a bar tonight?” may be transmitted with an image of an animated character drinking at a bar. After an image or animation has been generated, the user has the option of editing various aspects of it. For example, the user can change the character, background, music, and fonts before transmitting it to the recipient.

With the rapid and widespread adoption of wireless devices, such as cell phones, email pagers, and personal digital assistants (PDAs), wireless messaging and data transfer technologies have emerged. For example, wireless network carriers offer Short Message Services (SMS) to cell phone users allowing them the ability to send text messages to other cell phones. In addition, Nokia picture messaging allows users to send a graphic and a text message to others. WAP-enabled devices can access files and other data on application servers over a wireless computer network. In addition, wireless email pagers, such as Research In Motion, Inc.'s Blackberry®, allow users to send and receive emails wirelessly.

Graphical messaging technologies are currently being extended to wireless networks. For example, Funmail, Inc. of Pleasanton, Calif. has extended the concept disclosed in U.S. patent application Ser. No. 09/870,317 to cell phones. The extension of graphical messaging technologies, however, presents various technical challenges. For example, unlike the Internet where it can generally be assumed that client nodes, such as desktop and laptop computers, have a relatively comprehensive set of common functionality, the capabilities across the range of wireless devices varies considerably. The resulting range of mobile device configurations and capabilities presents challenges to reaching the largest possible population of users. For example, scripting languages vary across mobile devices. In addition, wireless mobile devices have varying WAP-enabled browsing implementations. Furthermore, relative to desktop and laptop computers, mobile wireless devices, due to their small size and cost considerations, have smaller screen sizes, limited color palettes, limited processing power, limited graphics display ability and varying formats, limited bandwidth, varying font capabilities. Moreover, mobile devices typically include only limited means of input, such as number pads, pen-based, touch-sensitive screens, and/or thumb-operated keyboards. Indeed, the relatively limited interfaces typically provided by mobile wireless devices renders it difficult to adapt web applications deployed over the Internet to wireless applications. However, as discussed above, mobile wireless devices may also include certain capabilities such as SMS or other notification functionality, as well as other integrated phone features (e.g., one-touch dialing, caller identification, etc.).

In light of the foregoing, a need exists for methods, apparatuses and systems facilitating the creation and delivery of graphically expressive messages between mobile wireless devices. The present invention substantially fulfills this need.

### SUMMARY OF THE INVENTION

The present invention provides methods, apparatuses and systems allowing users to send and receive character-based, graphically expressive messages using mobile wireless devices. In one embodiment, the present invention allows users to create and maintain a customized, easy-to-use visual messaging environment for use with wireless mobile devices having limited display and other interface capabilities. In one embodiment, the present invention allows users to establish a graphical character-based, messaging personality, including selectable images of the character that convey a certain mood. These and other characteristics of the present invention will become apparent with reference to the drawings and description of preferred embodiments provided below.

The present invention, in one embodiment, supports a variety of client device and platform types, such as WAP phones, PDAs, IMode phones, desktop computers and the like. In one embodiment, using a wireless mobile device such as a WAP-enabled cell phone, a user selects a recipient from his address book (or types in an address), chooses a character, selects a mood for that character, inputs a message and sends that message. The message is then transmitted to a database and stored in a neutral-format where it can be retrieved by the recipient using any Internet enabled-device such as a cell phone, PDA, or desktop computer.

### DESCRIPTION OF THE DRAWINGS

FIG. 1 is a functional block diagram illustrating application of an embodiment of the present invention to telecommunications network infrastructure.

FIG. 2 is a flow chart diagram setting forth the overall process flow associated with a user interface according to an embodiment of the present invention.

FIG. 3 is a flow chart diagram providing a method allowing for the generation of a graphically expressive message according to an embodiment of the present invention.

FIG. 4 is a flow chart diagram illustrating the process flow associated with providing messages to users.

FIG. 5 is a flow chart diagram setting forth the process flows relating to the configuration of user preferences.

FIG. 6 is a user interface facilitating the composition of a graphical message.

FIG. 7 is a user interface facilitating management of received messages.

FIG. 8 is a user interface adapted for displaying a selected message to a user.

FIG. 9 is a user interface presenting various account management options.

FIG. 10 is a user interface facilitating changes to a user's address book entries.

FIG. 11 is a user interface facilitating changes to a list of pre-defined text messages associated with a user account.

FIG. 12 is a user interface allowing for changes to a list of favorite characters associated with a user account.

FIGS. 13A-13E are flow chart diagrams illustrating the process flow associated with a user interface system adapted for a mobile wireless device having a limited display area relative to the user interfaces shown in the foregoing figures.

FIGS. 14A and 14B illustrate a mobile wireless phone including a character-based, graphically expressive messages according to one embodiment of the present invention.

### DESCRIPTION OF PREFERRED EMBODIMENT(S)

### I. OPERATING ENVIRONMENT

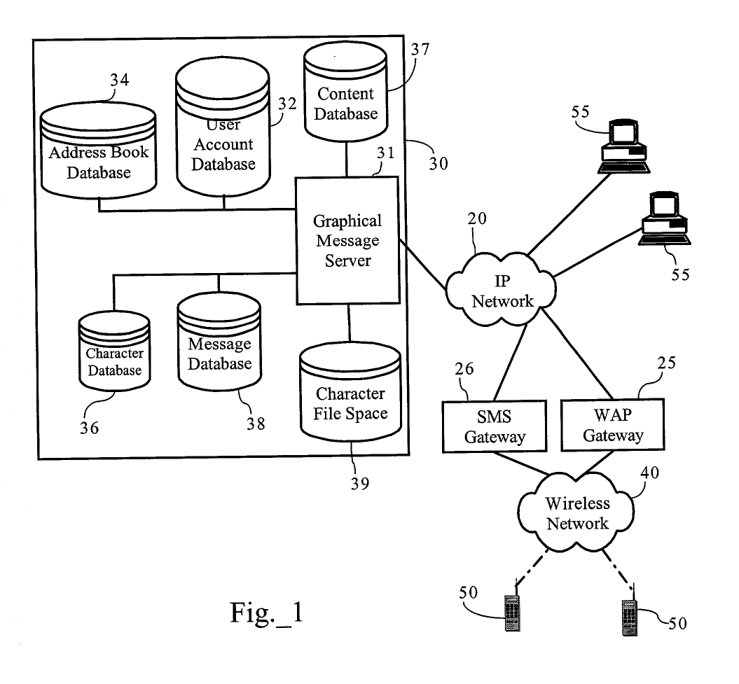

FIG. 1 illustrates a network environment including an embodiment of the present invention. Graphical messaging system 30 is operably connected to computer network 20 to transmit to and receive data from end systems and other nodes operably connected thereto, such as client computers 55. As FIG. 1 illustrates, the network environment further includes wireless network 40 allowing for transmission of voice and other data to mobile wireless devices 50. In one embodiment, wireless network 40 comprises WAP gateway 25 and SMS gateway 26.

Computer network 20, in one embodiment, is a packet-based communications environment, employing TCP/IP protocols and has a plurality of interconnected digital packet transmission stations operative to route data between TCP/IP end systems. The present invention, however, has application in computer network environments employing any suitable transport layer and network layer protocols. Client computers 55 are TCP/IP end systems operably connected to computer network 20 via any suitable means, such as through an Internet Services Provider (ISP) and the like. Client computers 55 can be any suitable internet-enabled computing device, such as a desktop computer, a laptop computer, or a PDA having wireless or wireline access to computer network 20 via, for example, a router (e.g., a wireless router executing the 802.11 wireless protocol in connection with a suitable equipped PDA), or via a Mobitex, DataTAC, GPRS, or any other packet-switched wireless network. In one embodiment, client computer 55 includes internet browsing software for receiving, displaying and transmitting data over a computer network.

A. Graphical Messaging System

As FIG. 1 illustrates, graphical messaging system 30, in one embodiment, 20 includes graphical message server 31, user account database 32, address book database 34, character database 36, content database 37, message database 38, and character file space 39. Graphical message server 31 is operative to execute the functionality, described herein, allowing users to create, send and receive character-based, graphically expressive messages. In one embodiment, graphical message server 31 operates in connection with user account database 32, address book database 34, character database 36, and message database 38. Graphical message server 31, in one embodiment, is operative to support access to the messaging functionality using a variety of client devices. For example, graphical message server 31, in one embodiment, hosts a web application providing HTML, Javascript, Flash, etc. content to client computers 55, and a WAP application providing WML, WMLScript, and WBMP content to WAP-enabled wireless devices 50. However, graphical message server 31 may operate in connection with any suitable wireless application protocol suite.

Content database 37 stores the content and other data necessary for operation of graphical messaging system 30, such as the user interfaces and various scripts necessary to dynamically generate various user interfaces. Many interfaces are supported by scripts operative to dynamically construct user interfaces and message displays and transmit them to recipient client devices. For example, as discussed more fully below, a message display interface is supported by a script operative to dynamically construct the message depending on various parameters, such as the selected character, mood, recipient device type, etc. As discussed above, content database 37 stores different versions of content (including a landing page, see below) adapted to the various devices supported by graphical messaging system 30. For example, content database 37 stores user interface data and files adapted for HTML-based browsers, and another set of WML data for WAP clients. Content database 37 can also store versions for various other wireless devices, such as IMode phones, Binary Runtime Environment for Wireless (BREW)-compliant, or Java2 Mobile Edition (J2ME)-enabLed devices. Of course, content versions may be adapted based on a variety of criteria including WAP client type, device type (e.g., phone v. PDA), rho product type, etc.

In one embodiment, the web-based component of graphical messaging system is configured primarily to support the mobile messaging application set forth herein. For example, the web application allows users to manage their respective user accounts in aspects that are more difficult using the limited interface capabilities of typical mobile wireless devices, such as editing user account preferences, changing address book entries and pre-defined message texts, custom character creation and upload, etc. Accordingly and in one embodiment, the HTML user interfaces are adapted to substantially mirror the user interface process flows associated with mobile wireless devices supported by the system. However, as discussed below, the web application also allows users to send and retrieve messages, in addition to managing aspects of the user account (e.g., changing account preferences and other settings). The web application also enables non-account holding or non-mobile recipients to retrieve and reply to messages.

User account database 32 stores user account data in association with corresponding users of graphical messaging system 30. In one embodiment, user account database 32 includes the following fields set forth in Table 1.

TABLE 1

| | |
|---|---|
| user_id | Unique User Identification (Primary Key) |
| f_name | First Name |
| l_name | Last Name |
| phone_num | Phone Number of Wireless Device |
| network | Unique Identifier for User's Wireless Network |
| | Carrier |
| pwd | Password Allowing Access to User Account |
| email_address | User's E-mail Address |
| fav_chars | List of the User's Favorite Characters |
| fav_phrases | List of the User's Preset Text Messages |
| notification | (on/off) Parameter Controlling Whether User |
| | is Notified of New Message |

Address book database 34 maintains a list of addresses for each user account. In one embodiment, address book database 34 is a simple 2×N table, where N represents the number of users maintained by the system, including a field identifying the user (such as user_id, above), and a field including a delimited list of other user identifications. In other embodiments, address book database 34 maintains a separate table or other data structure for each user address book, including such fields as first name, last name, nickname, phone number, e-mail address, etc.

Message database 38 stores message data corresponding to messages created by users. In one embodiment, each message is stored in a table including the following fields for each message: 1) a unique message identifier; 2) a recipient identifier; 3) a sender identifier; 4) a message character; 5) a message mood; 6) message text; 7) a date/time stamp; and 8) a flag indicating whether the message has been viewed. As discussed more fully below, a user accesses graphical message server 31 to create a message, resulting in the population of the message data fields described above.

Character database 36 maintains a plurality of character identifications and at least one mood in association with each character identification. Character file space 39 is maintained by a data storage device and includes the character image files specific to each mood associated with each corresponding character and specific to each device or platform type. In one embodiment, the character image files are optimized according to the graphical capabilities of the respective recipient device types. The character image files can be still images or animations. Depending on the recipient device, character files can be any suitable file format, including multimedia file formats, such as Flash®, QuickTime®, and RealPlayer® (intended for desktop or other platforms including the appropriate plug-in or other player), as well as other file formats intended for modern, HTML-compliant browsers. Such character image files may also be WBMP files intended for WAP-compliant devices, as well as other file formats for IMode technologies, Nokia Picture Messaging, Multimedia Messaging Service, BREW, etc.

In one embodiment, a file naming convention is imposed to facilitate retrieval of the appropriate character image file. For example, one file naming convention concatenates in order the character name, mood, and device type for which the animation file is intended. For example, assume a character “Bob” has been created with three moods “normal,” “angry,” and “sad.” Assume further that graphical messaging system 30 supports messaging using an I-mode phone (e.g., device_type=imode), a PDA based on the Palm® Operating System (device_type=palm), and a desktop computer with a browser and a Flash Media player Plug-in (device_type=flashPC). According to the file naming convention, the animation file for an “angry” Bob transmitted to an I-mode phone would be “bob.angry.imode”. In another embodiment, file name extensions map to device types. For example, a character file name intended for a browser including a Flash plug-in could be “bob.angry.swf,” while the same character-mood file for a WAP client would be “bob.angry.wbmp.”

The databases described above can be implemented in any suitable manner. In one embodiment, the data described above is stored in relational database system (e.g., a SQL database), wherein each of the databases described above is maintained as a separate table in the relational database system. Of course, the data described above may also be stored in a flat-file database, a hierarchical database, a network database, an object-oriented database, or an object-relational database.

B. Wireless Network

Wireless network 40 enables communication between wireless device 50 and other systems operably connected thereto. Wireless network 40 can be any suitable digital or analog wireless network, such as a Time Division Multiple Access (TDMA) network, a Global System for Mobile communication (GSM) network, or a Code-Division Multiple Access (CDMA) network. In one embodiment, wireless network 40 includes functionality supporting the Wireless Access Protocol (WAP), a set of communication protocols enabling wireless devices 50 to access the Internet or similar computer network. In one embodiment, wireless network 40 includes WAP gateway 25 and SMS gateway 26. In one embodiment, the functionality of SMS gateway 26 is integrated into WAP gateway 25.

WAP gateway 25 is operative to establish a connection (e.g., a Wireless Session Protocol (WSP) connection) with wireless device 50, receive requests designating an application server or other resource on computer network 20 from wireless device 50, translate the request into an HTTP or other suitable request to the appropriate application server, receive a response from the application server, and translate and transmit the response to wireless device 50. SMS gateway 26 allows nodes connected to computer network 20 to transmit SMS messages to wireless devices within the cell served by that gateway and/or to wireless devices 50 including roaming service capability.

Wireless devices 50 are operative to receive data from wireless network 40 and transmit data to wireless network 40 for routing to appropriate devices. Wireless devices 50, in one embodiment, are Internet-enabled devices capable of receiving data from remote servers and displaying data on a user interface screen. In one embodiment, wireless device 50 is a WAP-enabled device, such as a WAP mobile phone, including a WAP client (e.g., a WAE user agent, such as a WAP browser, and a WTA user agent). In another embodiment, mobile wireless device 50 can be a wireless PDA including HTML-compliant or HTML-supported browser functionality, such as Pocket PC including Pocket Internet Explorer® (PIE), which is a mobile-version of Microsoft's Internet Explorer®, including limited Javascript support and the ability to display HTML and flash files (assuming the Flash plug-in is installed). Graphical messaging system 30 can be configured to support a variety of wireless devices, including IMode phones, and mobile wireless devices including BREW, J2ME, or SMS/picture messaging technologies.

II. Operation

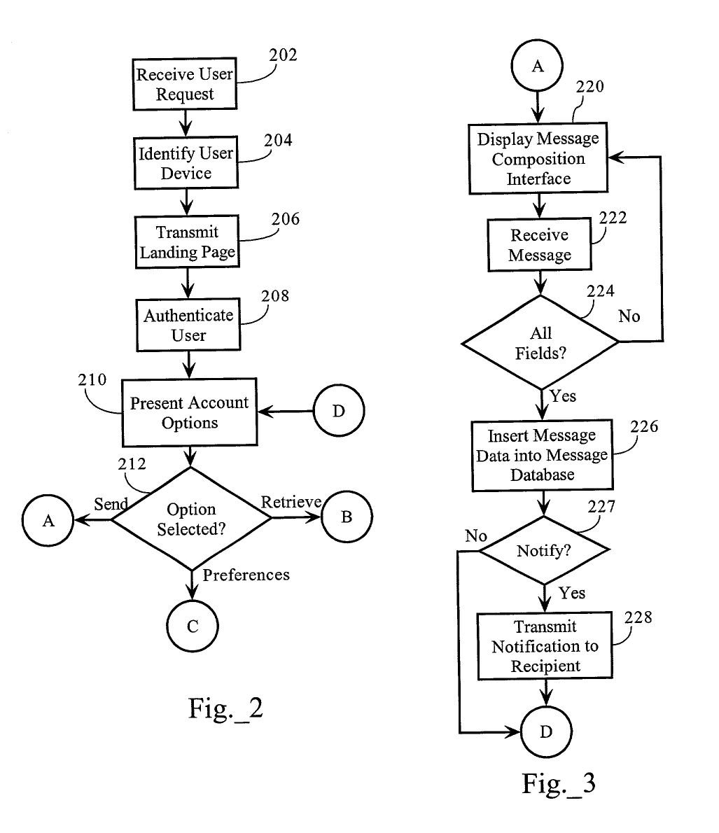

FIG. 2 sets forth the process flow associated with an embodiment of the present invention. In one embodiment, a user accesses graphical messaging system 30 by entering a corresponding URL into the browser of a client device (e.g., client computer 50 or wireless device 55), causing the browser to compose and transmit a request. When graphical message server 31 receives the request (step 202), it analyzes data in the request to identify the device (step 204). In one embodiment, all initial requests transmitted to graphical message server 31, are redirected to a routing script. The routing script evaluates a combination of parameters associated with the request. In the Internet computer network environment, these variables can include the HTTP_ACCEPT variable indicating which files the user agent (e.g., micro-browser on a WAP device, a Netscape browser on a desktop computer, etc.) can accept, and the HTTP_USER_AGENT variable identifying the user agent and version. In addition for international user agents, the HTTP_ACCEPT_LANGUAGE variable may also be analyzed to determine in which language to return a response. For example, an HTTP request transmitted by WAP gateway 25, essentially acting as a proxy for wireless device 50, may advertise its capability to accept WML, WMLScript and WBMP (Wireless Bitmap) files as reflected in the HTTP_ACCEPT parameter. Of course, the parameters and their significance may vary across devices and clients, as well as subsequent versions of each. Accordingly, the script must be adapted to recognize current devices based on a combination of parameters passed to it in the initial HTTP request. Based on the above evaluation, the script redirects the user to an appropriate landing page for the currently-used device and language (step 206). All subsequent requests branch from this landing page, so no further device identification is required for a session.

In one embodiment, the landing page prompts the user to provide a user name and password for authentication purposes (step 208). Numerous authentication protocols are known in the art. The particular authentication protocol used is not critical to the invention. In one embodiment, the records corresponding to each user account contain the user name and a salted one-way hash of the user's password. Therefore, each user is authenticated by hashing the inputted password with the “salt” and comparing the result to the hash value stored in the user's record. If there is a match, the user is deemed to be authentic. However, in another embodiment, the functionality of graphical message server 31 is integrated into the services provided by wireless network 40 obviating the need for an explicit login and, optionally, authentication of users (below). For example, the functionality of graphical message server 31 may be integrated into WAP gateway 25, still allowing users at client computers 50 to access the functionality described herein.

Upon proper authentication, graphical message server 31, in one embodiment, presents a home page interface including links to various account options (see steps 210 and 212), such as sending messages, checking messages, and managing user account preferences.

A. Sending Messages

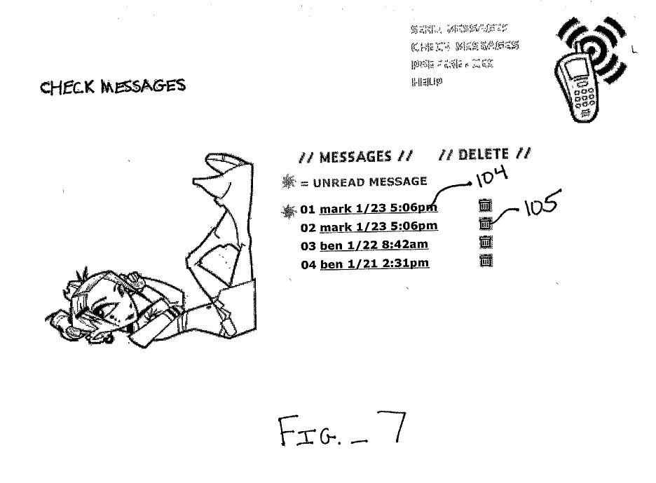

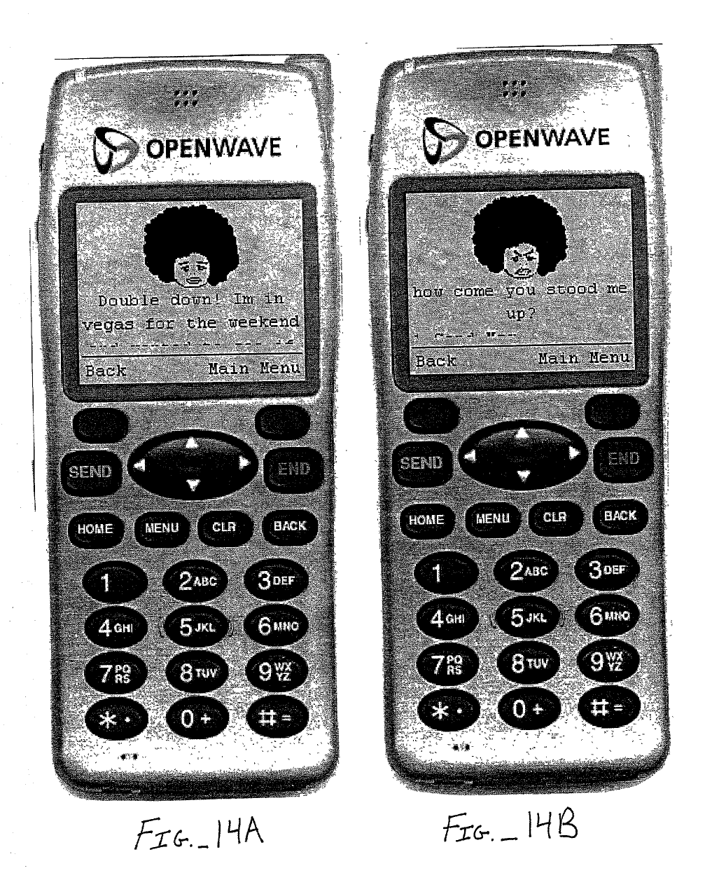

FIG. 3 sets forth a process flow associated with the composition of a message using a desktop or laptop computer including an HTML browser. FIG. 6 illustrates a message composition interface according to an embodiment of the present invention. In one embodiment, graphical message server 31 is operative to transmit interface data to a client device, to allow the client device to display a message composition interface (see FIG. 6) allowing the user to specify a recipient, a character, a mood for the character, and a text message (step 220). As discussed above, the selection of a character and a mood allows the sender to create and maintain a graphically expressive messaging personality. For example, as a user begins to use a particular character, recipients of messages from that user will begin to associate that character with the user. Moreover, if the user wishes to convey anger, the user may directly control such expression by selecting any “angry” mood, to select an image of the selected character having an angry expression. See, e.g., FIGS. 14A, and 14B. In one embodiment, graphical messaging system is configured to allow users to select moods that convey any of a variety of feelings, states of mind, expressions, tones, intensity levels, and emotional or mental states.

As FIG. 6 shows, the message composition interface includes a list of pre-written message texts. The use may click on one or more elements of the list 103 to add the underlying text to the message field 107. The user completes the required fields of the message composition interface and clicks on the “send” button, causing the browser on client computer 50 to transmit a request to graphical message server 31. In one embodiment, when graphical message server 31 receives the message composition request (step 222), it determines whether the request includes inputs for all required fields (step 224). If the request is incomplete, graphical message server 31 redirects the user to the message composition interface (step 220). In an alternative embodiment, some or all error checking is implemented by Javascript executing on the client device. Otherwise, graphical message server 31 inserts the message data into message database 38 in a device/platform neutral manner (step 226) and transmits a notification to the user (step 228).

In one embodiment, the message composition request transmitted to graphical message server 31 includes a subset of the message data fields discussed above. In one embodiment, the message composition request includes a 1) a recipient identifier; 2) a message character identifier; 3) a message mood identifier; and 6) message text. When graphical message server 31 receives the request it creates a unique message identifier and a date/time stamp based on the current date and time. Graphical message server 31 then inserts the message data into message database 38 setting the sender identifier field to the user identification associated with the user, and the “message_read” flag to “unread.”

In one embodiment, graphical messaging system 30 allows the user to specify whether and how to notify the recipient of the message. As discussed above, user account database 32 includes a “notification” field. If notification is activated for the account (see step 227), graphical message server 31 transmits a notification to the recipient. In one embodiment, graphical messaging system 30 allows the user to specify a notification mechanism. For example, graphical message server 31 may transmit a SMS notification to the recipient's cell phone via SMS gateway 26. Graphical message server 31 may also transmit an email notification to the recipient's email address.

B. Retrieving Messages

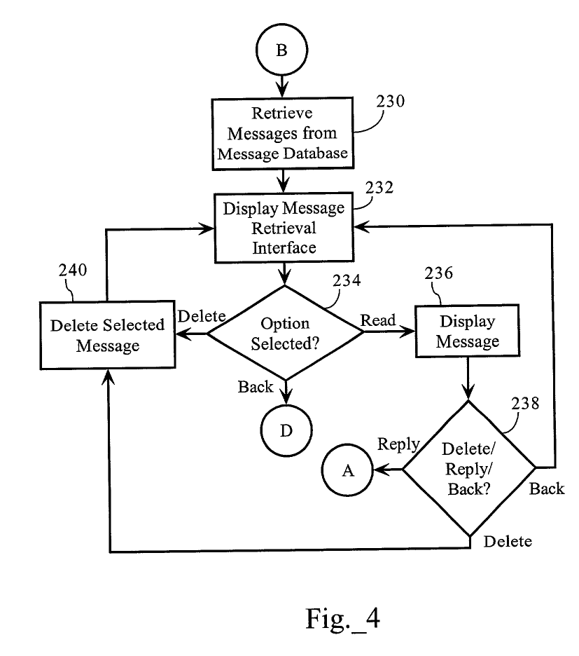

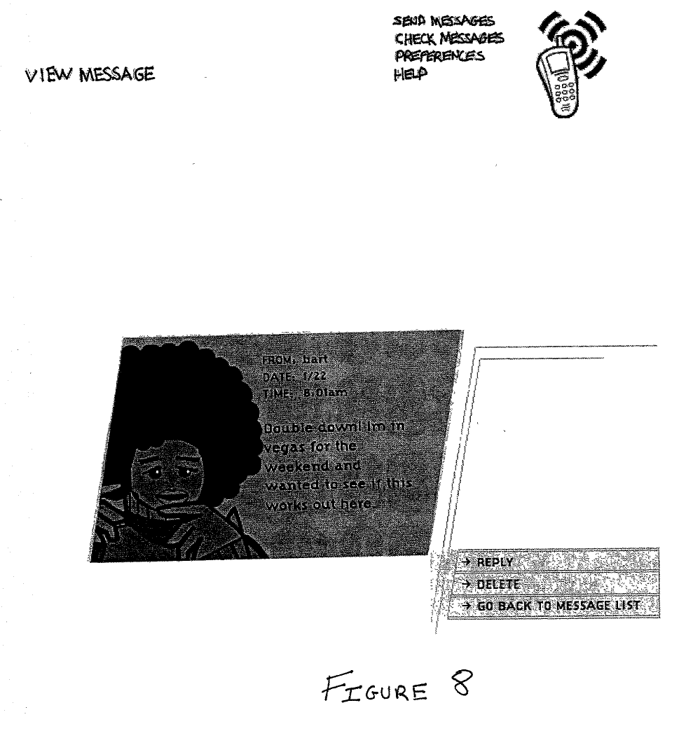

FIG. 7 illustrates a message retrieval interface suitable for a browser on a desktop computer, laptop computer, or any other client device featuring a sufficient display size. FIG. 4 sets forth a method associated with use of the message retrieval interface of FIG. 7. When a user opts to check received messages, graphical message server 31 retrieves all message entries where the user is identified in the recipient field (step 230) and displays a message retrieval interface including the list of retrieved messages (step 232). As FIG. 7 shows, the user may click on an individual message link 104 to view the message (see steps 234 and 236) or click on the delete control 105 to delete the message (see steps 234 and 240).

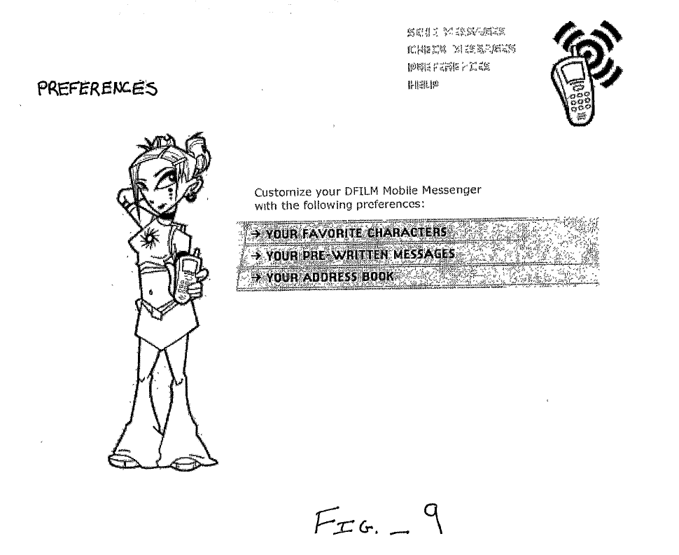

FIG. 8 sets forth a message display interface displaying a selected message and providing the user various options related to the message. As FIG. 8 illustrates, the user has the option (see also FIG. 4, step 238) to reply to or delete the message or go back to the message retrieval interface. As discussed above, in one embodiment, the page requested by the user includes a display script operative to dynamically create the message display interface based on the parameters associated with the message in message database 38. For example, the display script is operative to construct the file name for the image file corresponding to the selected character and mood, and the recipient user device type, based on the file naming convention discussed above. With the constructed filename, the script then retrieves the appropriate character image file from character file space 39 and constructs the message display interface. Of course, a variety of other methods could be used. For example, the display script may be configured to pass required parameters to character file space 39 which returns the appropriate image file.

In one embodiment, a non-account holder recipient is presented with a page containing the message sent by the user. Graphical messaging system 30 limits such non-accounting holding recipients to viewing and replying to the subject message.

C. User Account Preferences

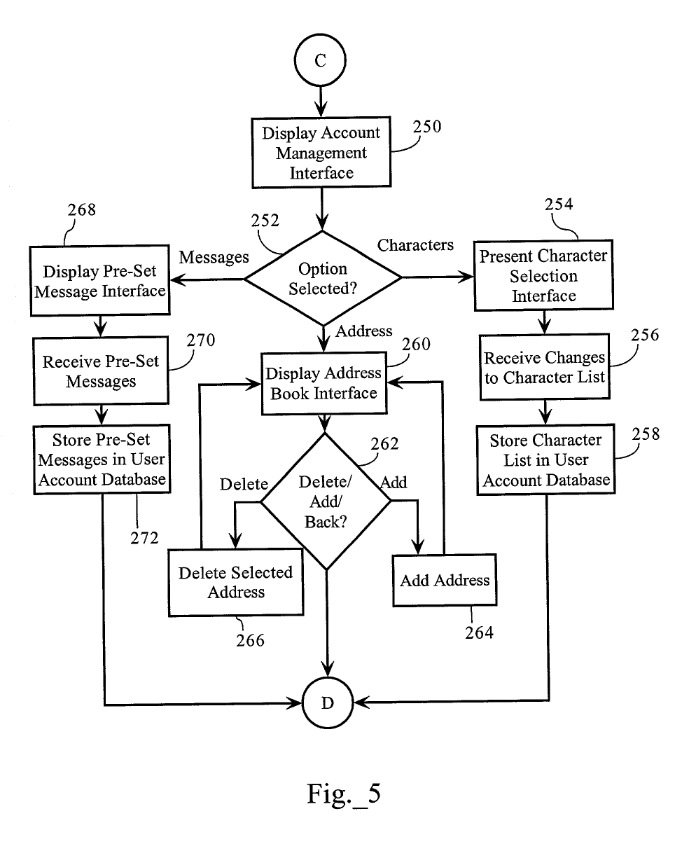

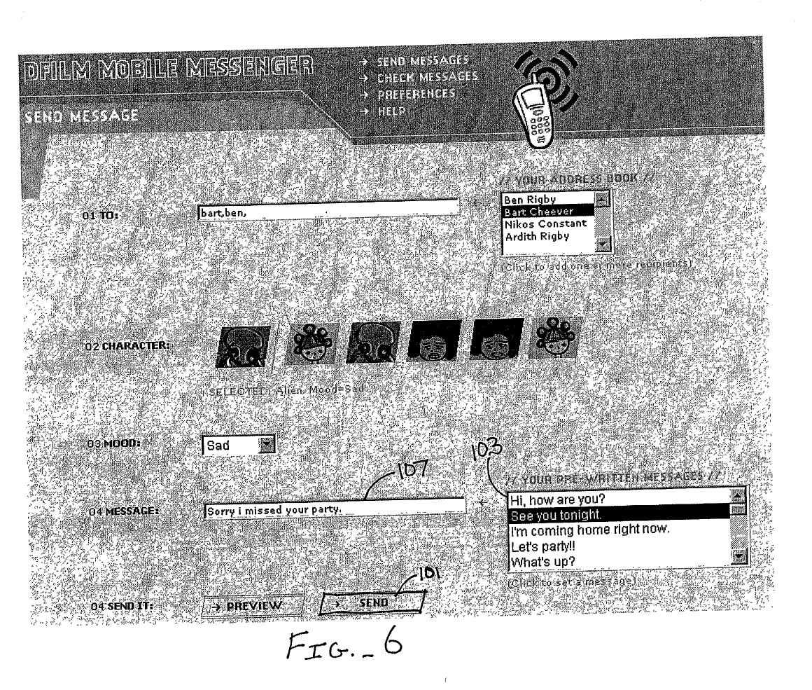

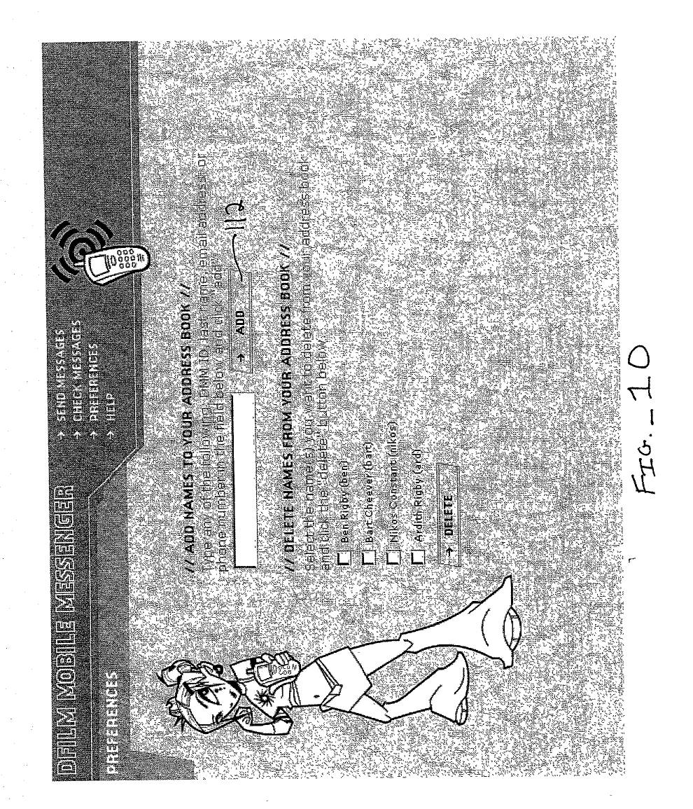

FIGS. 9 thru 12 provide account management interfaces facilitating the management of a user account according to an embodiment of the present invention. FIG. 5 shows a process flow associated with use of the account management interfaces shown in FIGS. 9 thru 12. As discussed above, when the user opts to change account preferences, graphical message server 31 transmits an account management interface to the user's browser for display (step 250) (see FIG. 9). In one embodiment, the user has the option to edit the list of favorite characters, change or add to the list of pre-written text messages, and change the user's address book entries (see step 252). Other account preference options can include a preference to turn notification on or off. In one embodiment, notification functionality transmits a daily email or SMS notification indicating how many read and unread messages a particular user has.

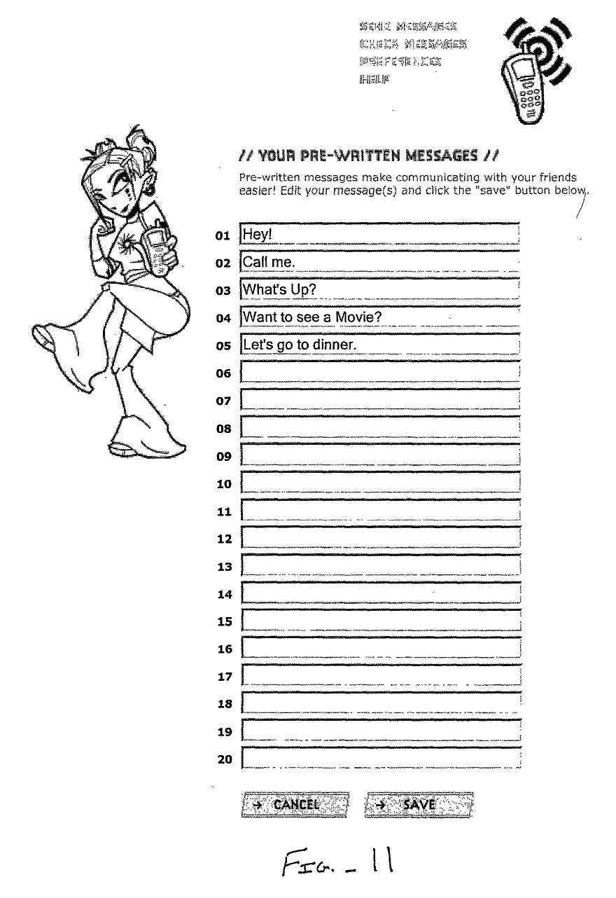

If the user opts to change the preset message interface, graphical message server 31 retrieves the list of pre-set text messages from user account database 28 and transmits the pre-set message interface (step 268). As FIG. 11 indicates, the use may change or add to the preset text messages using the provided fields and save the changes (see step 270). After graphical message server 31 receives the list of preset messages, it stores them in user account database 38 (step 272).

If the user elects to edit his or her address book, graphical message server 31 retrieves the addresses associated with the user identification corresponding to the user and displays the address book interface shown in FIG. 10 (step 260). As FIG. 10 indicates, the user may add an address by providing a user identification, name, email address or phone number and clicking the “add” button 112. Graphical message server 31 receives the request to add the specified address, locates a matching user account in user account database 38, and adds the entry to the user's address book in address book database 34 (see steps 262 and 264). Alternatively, the user may select an existing address book entry and delete it (see steps 262 and 266).

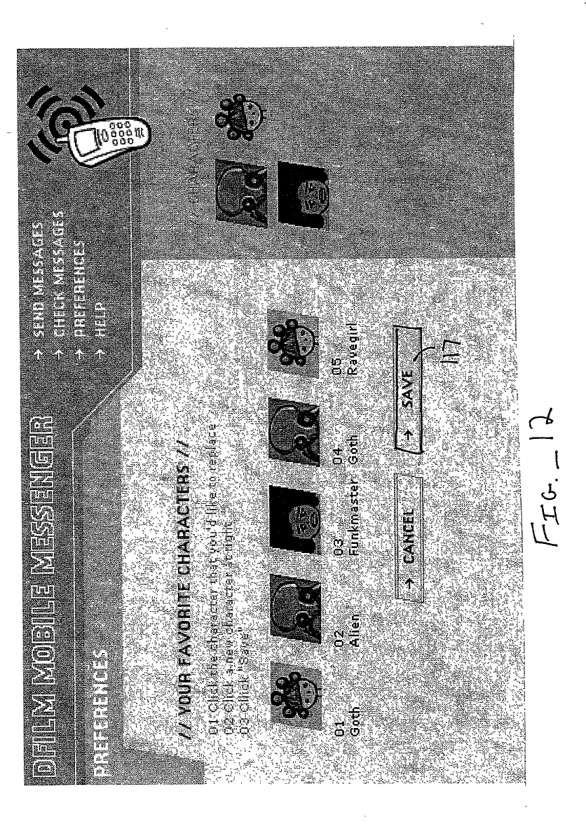

If the user opts to change his or her list of selectable favorite characters, graphical message server 31 presents a character selection interface to the user (step 254). FIG. 12 provides a character selection interface allowing the user to change the default list of selectable characters. Using the interface, the user configures the favorite character list and clicks “save” button 117, causing the user's browser to compose a request including the character names in the list. Graphical message server 31 receives the request (step 256) and stores the revised list in user account database 38 (step 258).

C.1. Automated Personalization

In one embodiment, graphical messaging system 30 maintains user profiles corresponding to users of the system and tailors the user's experience (e.g., modifying user interfaces, maintaining most used lists, enhancing account options, etc.) based on data associated with the user profile. Graphical messaging system 30 also permits users to configure the system according to their respective preferences.

C.1.a. Creating The User Profile

Graphical messaging system 30 creates a user profile by combining usage patterns with information provided by the user, during registration or subsequent to such registration. User-provided information may include personal information provided by the user and the user's mobile device, such as address, telephone number, age, gender, and other data gathered through user account sign-up, as well as device type and capabilities. In one embodiment, graphical messaging system 30 tracks usage patterns by monitoring usage and recording usage data in a database. For example and in one embodiment, graphical messaging system 30 maintains a database table with one row per user that tracks various usage patterns and preferences, such as characters selected, moods selected, and various information about messages typed. When possible, graphical messaging system 30 identifies the user's current physical location and, optionally, tracks location history. Physical Location information can be obtained from the wireless network carrier according to the cell tower currently in use by the user or by cell tower triangulation.

C.1.b. Personalization Based on the Profile

Graphical messaging system 30, in one embodiment, periodically analyzes user profiles and uses them in the various manners described below.

Character Ordering: When the user browses through the list of characters while configuring his or her “Favorite Characters” list, graphical messaging system 30 can place the most relevant characters first. For example, the system will check the user's zip code against a proprietary zip-code characteristics database and will order the character list to match possible interests for someone living in that zip code. For example, if the user's zip code is 94133 (San Francisco), the top several characters may be a San Francisco Giants player, a cable car conductor, and an Uncle Ben figure. If enough data is available, the system may also present characters that match the user's past interests. For example, if the user has selected a monster character for 80% of all messages, the system will display a series of other monster characters at the top of the list.

Easter Eggs: Graphical messaging system 30 may also use user profiles to present the user with “Easter Eggs,” rendering use of the system more of a game-like experience. For example, if a user selects the “Funkmaster” character 10 times in a row, the user will be granted access to “hidden” Funkmaster moods such as “Giving the Bird,” “Break dancing,” and “French Kissing.” Alternatively, if the user selects a monster type of character 20 times in a row, a secret monster character will be made accessible. Or, if the user selects a particular mood type 20 times in a row, such as angry, they will be given access to additional moods for each character of that type.

Personalized Ads: In one embodiment, graphical messaging system 30 is operative to deliver advertisements to user based on user profiles. In one embodiment, such ads are “pushed” to the user's device and selected according to location, time, user profile, and pre-configured preference. For example, if the user has elected to receive “Entertainment related push-ads” and is driving near a Blockbuster Video, he may receive a Blockbuster video character with the message “2 for 1 DVD rentals if you stop by in the next 30 minutes.” The system may also use data in the user's profile such as gender, top characters, and zip code to push particular ads.

C.1.c. User Configurable Preferences

Beyond the user preference features described above (e.g., pre-set messages, select “Favorite Characters,” and turn notification on or off), graphical messaging system 30 may be configured to support other customizable preference options, including:

Recipient Groups: The user will be able to place recipients into groups such as Family, School-Friends, and Skate-Friends. The user will then be able to set pre-written messages and top characters according to recipient group. For example, the top 2 pre-written messages for the family group may be “Be back from school at 5 pm” and “I'm on my way home right now,” while the top 2 pre-written messages for the skate-group may be “Just cut class, meet you at the ramp” and “Come over 4 Tekken 3.” Characters would also be appropriately arranged. In one such embodiment, after a user specifies a message recipient, graphical message server 31 scans the user account database 32 to determine whether the message recipient is associated with a group and adjusts subsequent message creations interfaces to present the top characters, top moods, and/or pre-written messages associated with the group.

Preferred Ad Groups: The user will be able to specify which types of ad-characters they'd like to receive. For example, a user may elect to receive movie, music, and food related ads, but not life insurance. The user may elect to receive location-based ads, but not ads based on time or personal profile.

C.2. Character Personalization Technologies

Graphical messaging system 30, in one embodiment, includes tools allowing users to create and upload customized characters for use in the graphically expressive messages according to the system.

C.2.a. Character Creation Tool

Graphical messaging system 30, in one form, includes web-based technologies allowing users to create and save new messaging characters. In one embodiment, the character creation tool interface displays a series of body parts and other physical character elements, such as skin color, hair, clothing, from which the user picks to assemble a customized character. In one embodiment, the character creation tool implementation is based on the Flash® Media Player, allowing the user to view the character progressively as he or she picks various body parts and other physical character elements. When finished, the user can give the character a name and save it. When the user saves the customized character, graphical messaging system 30, in one embodiment, saves the parameter set defining the selected parts and elements in a MySQL database. The user will be able to re-configure the character at any time by opening and editing the file using the character creation tool. In addition, after the character is saved, the user will be able to use the character in messages sent to other users.

When a complete character has been made, the character-creation tool sends the parameter set to a script. In one embodiment, the parameter set includes all character elements specified by the user, such as character name, head type, hair color, skin color, clothing style, etc., as well as the user identification corresponding to the user. The script is operative to cross-check the user's selections against a table that contains characters previously created by other users (existing characters). In one embodiment, the existing_character table contains a field for each of the possible character elements, as well as a unique char_code field which is used to identify that particular combination of characteristics. If the user's character, as represented by a combination of elements, does not already exist, the script will insert the new combination into the table and assign a unique char_code to it. The char_code will then be inserted (appended) into the char_shop_codes field of the user account database 32 for that user. If the char_code does already exist, the files will have already been generated and the script will simply update the char_shop_codes field in user account database 32 with the appropriate char_code for that character combination.

The script will then generate a set of graphical files using that particular combination of characteristics for each of the supported platforms and devices (WBMP, FLASH, gif89a, etc) and for each of the moods in the mood-set. The script will then save the files in a shared character_shop_files directory. This directory stores all of the graphical files needed for quick playback of the character-shop created characters. This system obviates the need to dynamically generate character files each time a customized-character is requested.

When a message is retrieved that requires the use of a character created by the character creation tool, the display script will detect that a customized character is needed by a code in the character's name. The script will insert a reference to the appropriate graphical file using the code, which will point to the correct file in the character-shop-files directory. Otherwise, the character display will be consistent with the description of the graphical messaging system 30 provided above.

C.2.b. Character Upload

Graphical messaging system 30, in one embodiment, further includes character upload functionality allowing technologically savvy users to completely control the appearance of their characters. In one embodiment, graphical messaging system 30 provides a simple web interface allowing users to upload and save appropriately formatted graphical files. These files represent all of the graphical files required by graphical messaging system 30 for the display of a character. Advertisers, for example, can use this technology to upload branded characters for use by users generally or for use in the Ad-Push program, where advertisers can “push” a character-based ad to a user as he walk or drive past the advertiser's physical location, or at an appropriate point in time (see above).

In one embodiment, the character upload interface is implemented in HTML. The first page will describe the requirements necessary to create a character, provide a link to downloadable instructions and templates, and a link to the upload page. The upload page will allow users to select a “zipped” file from their desktop computer, to name their new character, list available moods, and to upload it to graphical messaging system 30. The upload page will also provide an option to “Add Moods” to a character that has previously been uploaded by that user. When the zipped file is uploaded, it will be processed by a script (e.g., a PHP script). First, the script will unzip the zip file. It then checks that the user has provided all of the necessary files and named each file according to the requisite naming conventions. If the user has provided all of the appropriate files, the script will:

Check the file quota for that user's personal directory. If there is no existing directory for that user (if this is the first time that they have uploaded a character), a directory will be created and named according to the user's identification. If adding the new files to the user's directory will exceed the user's quota, the script will return with an error message.

If the quota will not be exceeded, the script will move all files to the user's personal directory.

The script will then insert (append) a new entry to the uploaded-characters field in user account database 32. The entry will contain the new character's name. However, if the user is adding moods to an existing character, the script will append moods to the existing character definition in the uploaded_characters field.

When a message is retrieved that requires the use of an uploaded character, the display script will detect that an uploaded character is needed by a code in the character's name. The script will insert a reference to the appropriate graphical file using the code, which will point to the correct file in the user's personal directory. Otherwise, the character display will be consistent with the description of the graphical messaging system 30 provided above.

C.2.c. Photo To Mobile

In one embodiment, graphical messaging system 30 includes functionality allowing users to upload a photo and to use the photo image as a character in the system. While the uploaded photo can technically contain any subject matter, interfaces associated with the photo upload tool includes instructions to recommend a headshot set against a white wall. The system will be optimized for such a photo.

In this manner, graphical messaging system 30 allows users to employ an image of themselves as a character. Users can upload photos of themselves in different moods, thereby enabling them to express a range of emotions. When used to display images of one's face in different moods, graphical messaging system 30 emulates a low-bandwidth video phone.

In one embodiment, the web-based, photo upload interface will be implemented in HTML. The first page will describe the recommended photo technique (i.e., stand against a white wall, use the flash, position camera so that bottom of frame comes to the shoulders and the top of the frame cuts off just above the head). It will also provide a link to sample photos and an upload page. The photo upload interface will allow users to select a photo file from their desktop computer, to name their new character, list the appropriate mood displayed in that photo, and to upload it to graphical messaging system 30. The upload interface will also provide an option to “Preview Photo,” which will show the user what their photo will look like when converted to the file formats supported by graphical messaging system 30.

When the graphical file is uploaded, it will be processed by a script written, for example, in C, C++, Java, and/or PHP. The script will:

Convert the file into the formats supported by graphical messaging system 30 (Flash, WBMP, etc). It will convert the file by running it through a combination of Macromedia's Generator and proprietary image processing software.

If “Preview Photo” was selected, the script will display the graphical results to the user and will exit.

If “Upload a Save Photo” was selected, the script will insert (append) the new character's name and mood to the photo_to_mobile_characters field in user account database 32. It will then check the user's quota, and, if there is room available, move the graphical files to the user's personal directory. If the quota is exceeded, the program will return an error message and exit.

Similar to that described above, when a message is retrieved that requires the use of a Photo-To-Mobile character, the display script will detect that a Photo-To-Mobile character is needed by a code in the character's name. The script will insert a reference to the appropriate graphical file using the code, which will point to the correct file in the user's personal directory. In all other ways, the character display will be consistent with the existing system.

D. Exemplary Interface Adapted to Wireless Mobile Devices

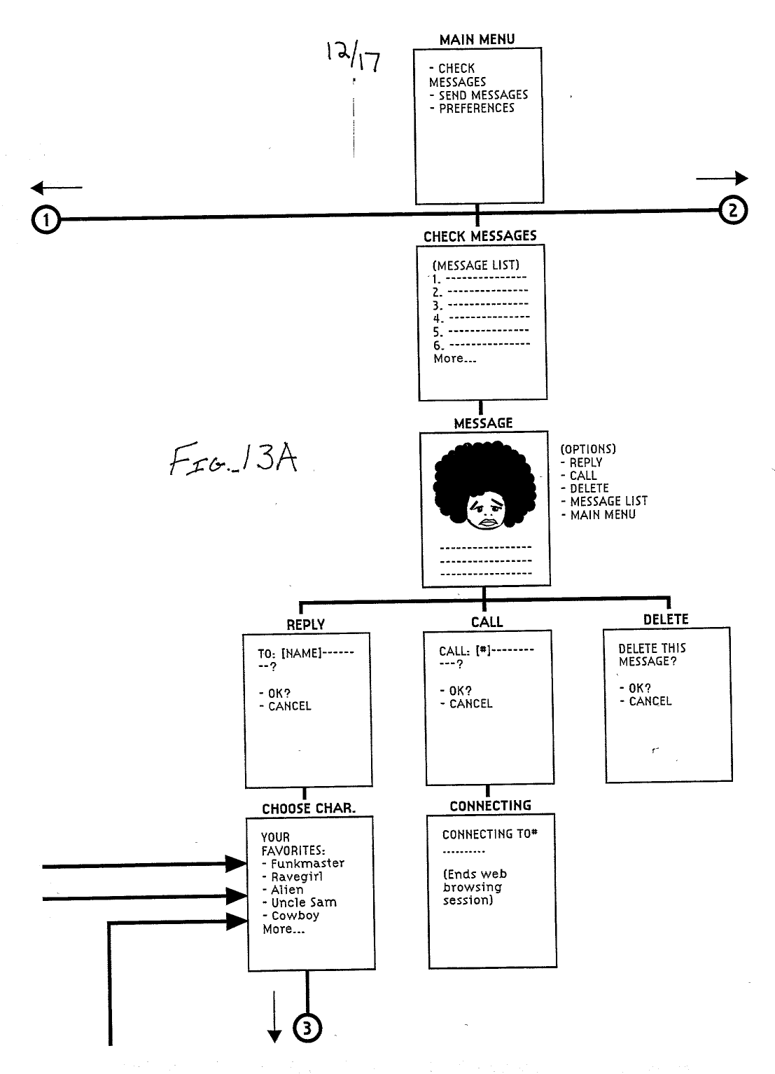

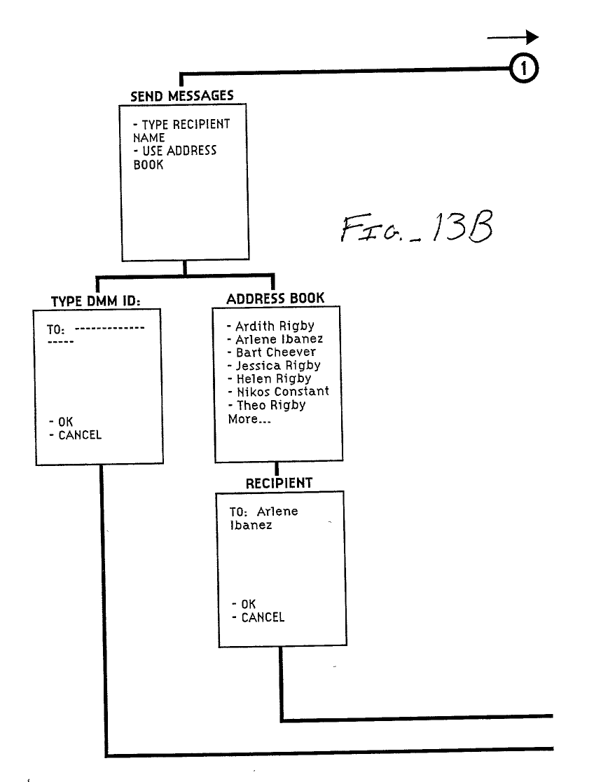

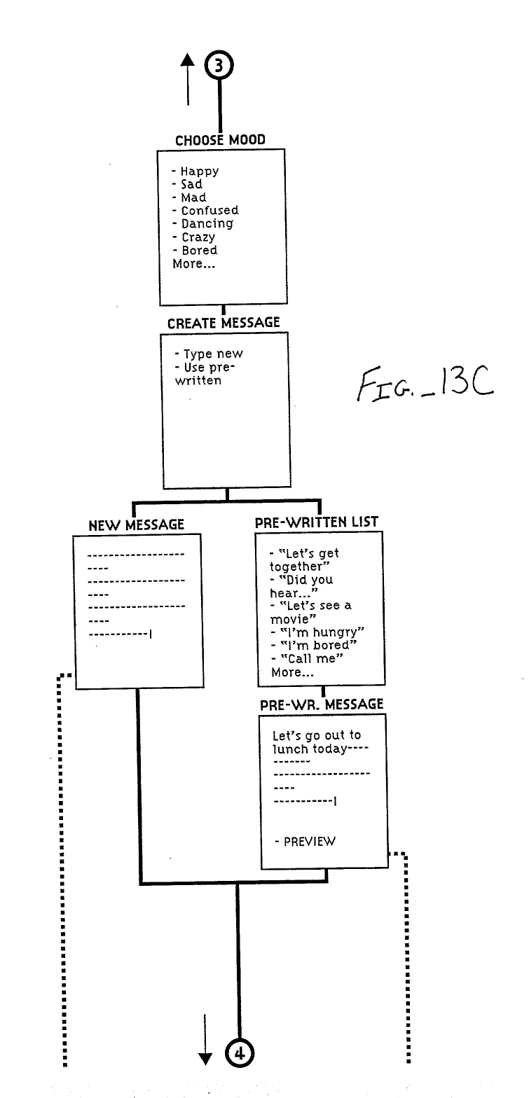

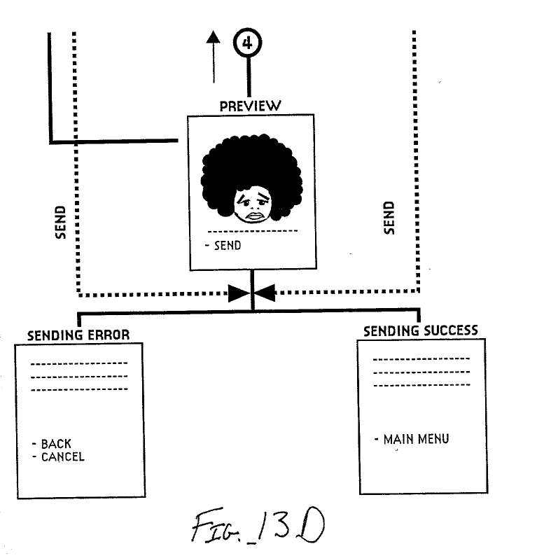

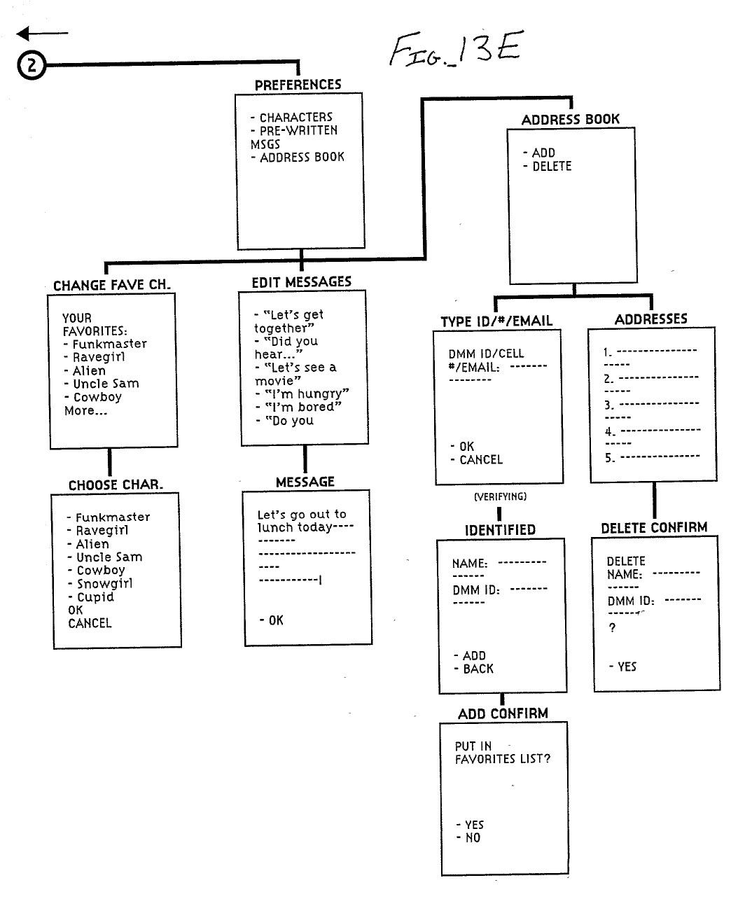

FIGS. 13A thru 13E illustrate the process flow associated with a user interface system adapted for a mobile wireless device having a limited display area relative to the user interfaces intended for desktop and laptop computers, shown in the foregoing figures. The wireless application, in one form, is configured to be substantially consistent with the web application, at least as to the interfaces and other aspects of the experience relative to the user. As the various Figures indicate, the wireless application supported by graphical messaging system 30, according to one embodiment of the present invention, allows the user to accomplish the same tasks as the web-based application. In addition, the maintenance of a user account and the various settings and preferences associated therewith facilitates use of the system given the relatively limited interface capabilities of most mobile wireless devices, such as cell phones and PDAs. Still further, the wireless application integrates the underlying functionality of the mobile wireless device. For example, the wireless application allows users to call the sender in reply to a message.

Lastly, although the present invention has been described as operating in connection with end systems employing the TCP and IP protocols, the present invention has application in computer network environments employing any suitable transport layer and network layer protocols. Moreover, while the embodiments described above operate primarily in connection with an independent messaging system, graphical messaging system 30 could be integrated into WAP gateway 25 provided by a wireless network carrier, or otherwise integrated into the functionality and services available over wireless network 40. Accordingly, the present invention has been described with reference to specific embodiments. Other embodiments of the present invention will be apparent to one of ordinary skill in the art. It is, therefore, intended that the claims set forth below not be limited to the embodiments described above.

What is claimed is:

1. A system enabling a character-based, graphically expressive messaging service for mobile, wireless devices, comprising:
a character file database storing, for at least one character, a set of image files corresponding to a plurality of moods for each character;
a messaging server operative to present a user interface facilitating the composition of a character-based, graphically expressive message;
the user interface allowing the user to select a character and a mood for the message;
the user interface allowing the user to input text and identify a message recipient;
wherein the messaging server is operative to transmit to the message recipient a message including an image of the selected character in the selected mood and the text inputted by the user.

2. The system of claim 1 wherein the user interface allows the user to select a character from a list of selectable characters.

3. The system of claim 1 wherein the user interface allows the user to select a mood from a list of selectable moods.

4. The system of claim 1 wherein the user interface includes a set of selectable pre-defined text messages.

5. The system of claim 1 wherein the user interface includes a set of selectable message recipients.

6. The system of claim 1 wherein each image file represents an animated sequence of images.

7. The system of claim 1 further comprising a user account database storing user account data and preferences for individual users.

8. The system of claim 7 wherein the user account database includes a list of favorite characters for each user account; and wherein the user interface allows the user to select a character from the list of favorite characters.

9. The system of claim 1 further comprising an address book database storing lists of message recipients in association with individual user accounts; and wherein the user interface allows the user to select a message recipient from the list of message recipients associated with the user account corresponding to the user.

10. The system of claim 1 further comprising a message database storing messages created by users using the user interface; wherein the message server is operative to store message data in pre-defined message data fields in the message database.

11. The system of claim 10 wherein the message data fields for each message include a character identifier and a mood identifier; and wherein the message server is operative to construct a character-based graphically expressive message based on the character identifier and mood identifier values associated with a message.

12. The system of claim 2 further comprising a user account database storing, for a given user account, at least one recipient user group in association with a list of selectable characters; and wherein the messaging server is operative to associate a message recipient with a recipient user group and adapt the user interface to present the list of characters associated with the corresponding recipient user group.

13. The system of claim 12 wherein the user account database further stores, for a given user account, at least one recipient user group in association with a list of selectable moods; and wherein the messaging server is operative to associate a message recipient with a recipient user group and adapt the user interface to present the list of moods associated with the corresponding recipient user group.

14. The system of claim 2 wherein the messaging server is operative to record usage data characterizing use of the messaging server in association with individual user accounts, and wherein the list of selectable characters is ordered, for a given user, based on the usage data associated with the corresponding user account.

15. The system of claim 3 wherein the messaging server is operative to record usage data characterizing use of the messaging server in association with individual user accounts, and wherein the list of selectable moods is ordered, for a given user, based on the usage data associated with the corresponding user account.

16. The system of claim 1 further comprising a character creation module allowing a user to create a character from a plurality of pre-existing character elements, store the character in the character file database to allow for subsequent selection of the character using the user interface.

17. The system of claim 1 further comprising a character upload module allowing a user to upload a character image file in the character file database in association with a character identifier and a mood identifier to allow for subsequent selection of the character file using the user interface.

18. The system of claim 17 wherein the character image file is a digital photo image.

19. A system enabling a character-based, graphically expressive messaging service for mobile, wireless devices, comprising:
a character file database storing, for at least one character, a set of image files corresponding to a plurality of moods for each character;
a content database storing user interface data allowing a client device to display a user interface facilitating the composition of a character-based, graphically expressive message; the user interface data allowing for selection of a character and a mood for the message; the user interface data allowing the user to input text and identify a message recipient; and
a messaging server operative to:
receive a request from a client device associated with a user;
retrieve user interface data in the content database and transmit the user interface data to the client device associated with the user;
receive a request to transmit a message composed by the user using the client device; and
transmit to the message recipient a message including an image of the selected character in the selected mood and the text inputted by the user.

20. The system of claim 19 wherein the user interface data allows the user to select a character from a list of selectable characters.

21. The system of claim 19 wherein the user interface data allows the user to select a mood from a list of selectable moods.

22. The system of claim 19 wherein the user interface data includes a set of selectable pre-defined text messages.

23. A system enabling a character-based, graphically expressive messaging service for mobile, wireless devices, comprising:
a character file database storing at least one character identifier and a plurality of mood identifiers associated with each character identifier;
a character file space storing a set of image files for each mood identifier associated with each character identifier in the character file database, each file in the set of image files associated with a device type;
a message database storing messages created by users; and
a messaging server operably connected to a telecommunications network to receive data from and transmit data to devices operably connected to the network; wherein the messaging server is operative to present a user interface facilitating the composition of a character-based, graphically expressive message;
the user interface allowing the user to select a character and a mood for the character;
the user interface allowing the user to input text and identify a message recipient;
wherein the message server is operative to store message data in pre-defined message data fields in the message database;
wherein the message server is operative to:
receive a request from a recipient user using a device connected to the network;
identify a device type corresponding to the device;
extract from the message database message data associated with a message sent to the recipient user;
construct a message based on the message data in the message database, and the image file corresponding to the character identifier and mood identifier contained in the message data and the identified device type; and,
transmit the message to the device associated with the recipient user.

24. The system of claim 23 further comprising a content database storing message application content and interfaces for a plurality of device types; and wherein the message server is operative to identify the device type corresponding to a device associated with a user and direct requests from the device to application content and interfaces specific to the identified device type.

25. The system of claim 23 wherein the user interface allows the user to select a character from a list of selectable characters.

26. The system of claim 23 wherein the user interface allows the user to select a mood from a list of selectable moods.

27. The system of claim 23 wherein the user interface includes a set of selectable pre-defined text messages.

28. The system of claim 23 wherein the user interface includes a set of selectable message recipients.

29. The system of claim 23 wherein each image file represents an animated sequence of images.

30. The system of claim 23 further comprising a user account database storing user account data and preferences for individual users.

31. The system of claim 30 wherein the user account database includes a list of favorite characters for each user account; and wherein the user interface allows the user to select a character from the List of favorite characters.

32. The system of claim 23 further comprising an address book database storing lists of message recipients in association with individual user accounts; and wherein the user interface allows the user to select a message recipient from the list of message recipients associated with the user account corresponding to the user.

33. A method enabling a character-based, graphically expressive messaging service for mobile, wireless devices, the method comprising:
creating a character file database storing at least one character identifier and a plurality of mood identifiers associated with each character identifier;
creating a character file space storing a set of image files for each mood identifier associated with each character identifier in the character file database, each file in the set of image files associated with a device type;
receiving from a first device a request to send a message to a recipient user, the request including a character identifier, a mood identifier and message text;
storing the character identifier, the mood identifier and the message text in a message database;
receiving a request from a second device associated with the recipient user;
identifying the device type corresponding to the second device;
retrieving the message data associated with the message in the message database;
retrieving the character image file from the character file space corresponding to the character identifier, the mood identifier, and the identified device type;
constructing the message including the character image file and the message text; and
transmitting the constructed message to the second device.
